(19) United States
(12) Patent Application Publication
(10) Pub. No.: US 2007/0040292 A1
(43) Pub. Date: Feb. 22, 2007

(54) Polypropylene composition for high gloss retention

(75) Inventors: John Ashbaugh, Houston, TX (US); Mike Musgrave, Houston, TX (US)

Correspondence Address: FINA TECHNOLOGY INC, PO BOX 674412, HOUSTON, TX, 77267-4412, US

(73) Assignee: Fina Technology, Inc.

(21) Appl. No.: 11/209,158

(22) Filed: Aug. 22, 2005

(51) Int. Cl. C08J 5/00; B29C 47/00; B29C 49/00

(52) U.S. Cl. 264/40.1; 264/331.17; 264/176.1; 264/211; 264/555; 264/537; 264/540; 264/531

(57) ABSTRACT

A method of manufacturing an end-use article from a polymeric composition comprising forming an intermediate article of the polymer composition into the end-use article having a gloss retention of greater than about 40%. A method of manufacturing an end-use article from a polymeric material comprising producing an intermediate polymeric article, determining the gloss of the intermediate article, converting the intermediate article to an end-use polymeric article, determining the gloss of the end-use polymeric article and calculating the gloss retention of the end-use article. A method of increasing the gloss retention of a polymeric article, comprising: fabricating an intermediate article from a polymeric composition comprising a metallocene-catalyzed polypropylene and a nucleator, clarifier, or both; and further processing the intermediate article to an end-use article.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

1. Field of the Invention

This invention relates to polymeric compositions and end-use articles made from same. More specifically, this invention relates to polypropylene compositions and end-use articles having high gloss retention.

2. Background of the Invention

Synthetic polymeric materials, particularly plastic resins, are widely used in the manufacturing of a variety of end-use articles ranging from medical devices to food containers. An issue of commercial importance in terms of marketing is the final appearance of the end-use article. Current manufacturing methods often begin with the production of a preform or intermediate article from resin pellets. This preform is designed so as to allow its facile conversion to any number of end-use articles through a plastics shaping process. Several different shaping processes that include thermoforming, injection molding, blow molding, and rotational molding can be used to convert the preform into end-use articles. The shaping processes employ heat and/or pressure to convert the polymeric material into the desired end-use article.

The convenience of using a preform in the manufacture of synthetic polymeric materials is offset by the potential negative impact of additional processing on the appearance of the end-use article. Particularly, a polymeric material chosen for both its mechanical properties and aesthetically appealing high gloss, may suffer a significant a reduction in gloss upon processing from an intermediary preform to the end-use article. Consequently, the manufacturing efficiency obtained by using preforms has to be balanced with the decrease in aesthetic appeal to the consumer. Therefore, it would be desirable to develop a synthetic polymeric material having an increased ability to retain gloss after being processed from a preform into an end-use article. It would also be desirable to develop a methodology for the manufacture of an end-use article having increased gloss retention.

### BRIEF SUMMARY OF SOME OF THE PREFERRED EMBODIMENTS

Disclosed herein is a method of manufacturing an end-use article from a polymeric composition comprising forming an intermediate article of the polymer composition into the end-use article having a gloss retention of greater than about 40%.

Further disclosed herein is a method of manufacturing an end-use article from a polymeric material comprising producing an intermediate polymeric article, determining the gloss of the intermediate article, converting the intermediate article to an end-use polymeric article, determining the gloss of the end-use polymeric article and calculating the gloss retention of the end-use article.

Further disclosed herein is a method of increasing the gloss retention of a polymeric article, comprising: fabricating an intermediate article from a polymeric composition comprising a metallocene-catalyzed polypropylene and a nucleator, clarifier, or both; and further processing the intermediate article to an end-use article.

The foregoing has outlined rather broadly the features and technical advantages of the present invention in order that the detailed description of the invention that follows may be better understood. Additional features and advantages of the invention will be described hereinafter that form the subject of the claims of the invention. It should be appreciated by those skilled in the art that the conception and the specific embodiments disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### DETAILED DESCRIPTION OF THE PREFERRED EMBODIMENTS

Intermediate and end-use articles are prepared from a polymeric composition comprising a metallocene-catalyzed polymer of propylene (mPP) and a modifier. The mPP may be a homopolymer or a copolymer, for example a copolymer of propylene with one or more alphaolefin monomers such as ethylene, butene, hexene, etc. Homopolymer mPP, including the propylene homopolymer portions of copolymers, may be isotactic (miPP). The mPP may have a molecular weight distribution of from less than 4.0, alternatively from about 2.0 to about 3.5. In an embodiment, the mPP is a random ethylene-propylene (C₂/C₃) copolymer and may comprise from about from about 0.2 wt. % to about 5 wt. % ethylene, alternatively from about 0.4 wt. % to about 3 wt. % ethylene. An example of a suitable miPPs is a propylene homopolymer sold as M3282MZ by Total Petrochemicals USA, Inc. In an embodiment, the miPP (e.g., M3282MZ) has about the physical properties set forth in Table I.

TABLE I

| | Typical Value | ASTM Method |
|---|---|---|
| Resin Properties⁽¹⁾ | | |
| Melt Flow, g/10 min. | 2.3 | D 1238 Condition “L” |
| Density, g/cc | 0.905 | D 1505 |
| Melting Point, ° F. (° C.) | 307 (153) | DSC⁽²⁾ |
| Mechanical Properties⁽¹⁾ | | |
| Tensile, psi (MPa) | 4,900 (33.8) | D 638 |
| Elongation, % | >72 | D 638 |
| Flexural Modulus, psi | 216,000 (1,490) | D 790 |
| (MPa) | | |
| Izod Impact @ 73° F. | | D 256A |
| Notched-ft.lb./in. (J/m) | 1.3 (65) | |
| Thermal Properties⁽¹⁾ | | |
| Heat Deflection | | D 648 |
| ° F. at 66 psi | 207 | |
| ° C. at 4.64 kg/cm² | 97 | |

⁽¹⁾Data developed under laboratory conditions and are not to be used as specification, maxima or minima.
⁽²⁾MP determined with a DSC-2 Differential Scanning Calorimeter.

Metallocene-catalyzed polypropylene may be formed by placing propylene alone or in combination with one or more comonomers (e.g., ethylene) in a suitable reaction vessel in the presence of a metallocene catalyst and under suitable reaction conditions for polymerization thereof. In random C₂/C₃ copolymers, the ethylene molecules are inserted randomly into the polymer backbone between repeating propylene molecules, hence the term random copolymer. Using a metallocene catalyst to form the random copolymer may allow for better control of the crystalline structure of the copolymer due to its isotactic tendency to arrange the attaching molecules. The metallocene catalyst ensures that a majority of the propylene monomer is attached so that the pendant methane groups (—CH₃) line up in an isotactic orientation (i.e., on the same side) relative to the backbone of the molecule. The ethylene units do not have a tacticity as they do not have any pendant units, just four hydrogen (H) atoms attached to a carbon backbone. (C—C).

Standard equipment and procedures for polymerizing the propylene and ethylene into a random copolymer are known to one skilled in the art. Isotactic ethylene-propylene random copolymers may be prepared through the use of metallocene catalysts of the type disclosed and described in further detail in U.S. Pat. Nos. 5,158,920, 5,416,228, 5,789,502, 5,807,800, 5,968,864, 6,225,251, and 6,432,860, each of which are incorporated herein by reference.

The polymeric composition may comprise a modifier such as a nucleator or clarifier in amounts of from about 200 ppm to about 4000 ppm by weight. A nucleator or a clarifier may be added to enhance the aesthetic appeal of a formed product by making it more transparent and/or retain gloss following processing. These modifiers may also help to improve the resin's processing productivity by speeding up the cycle and also may enhance performance properties such as stiffness and heat resistance.

Herein nucleators refer to compounds that increase the rate of crystallization of the polymer. Herein clarifiers refer to a subset of nucleators that increase both the rate of crystallization and the optical properties of the polymeric materials. During crystallization of a polymer such as PP, the crystals formed are typically larger than the wavelength of light. Crystals of this size refract light and thus can reduce the clarity of the copolymer. Without wishing to be limited by theory, a nucleator may provide a heterogeneous surface that acts as a crystallization site and increases the rate of polymer crystallization. In the presence of a nucleator, crystals may form at higher temperatures and the higher rate of crystal formation induces the formation of smaller crystals such as spherulites. The smaller crystals size allows light to pass with reduced refraction, thereby increasing the clarity and gloss of the polymer. Both clarifiers and nucleators increase the rate of crystallization of the polymeric material resulting in improved mechanical properties such as hardness, modulus and Izod impact resistance. However, while all clarifiers nucleate not all nucleators clarify although typically addition of a nucleator will result in some improvement in optical properties.

In an embodiment, any nucleator or clarifier chemically compatible with the polymeric composition, e.g., a C₂/C₃ random copolymer, and that is able to improve the optical properties thereof may be included in the composition. Such nucleators or clarifiers may be added in amounts effective to impart the desired properties.

In an embodiment, the nucleator is an aromatic carboxylic acid salt, alternatively a metal benzoate, alternatively sodium benzoate, alternatively lithium benzoate and is present in amounts from about 500 ppm to about 3000 ppm. Alternatively, the nucleator may be an organophosphate present in amounts of from about 300 ppm to about 1200 ppm. Alternatively, the nucleator may be talc present in amounts of from about 1000 ppm to about 4000 ppm. Alternatively, the nucleator may be a pine rosin present in amounts of from about 1000 ppm to about 4000 ppm.

The nucleator and clarifier may function as a single entity. In an embodiment, a modifier that may function as both a nucleator and clarifier is a sorbitol compound or derivative of sorbitol, alternatively dibenzylidene sorbitol. The all-organic sorbitol-based modifier may dissolve in the polymeric composition at temperatures of from about 390° F. to about 430° F. Without wishing to be limited by theory, the dissolving action of the sorbitol may contribute to greater clarity by further reducing the size of the crystallites. In an embodiment, a sorbitol modifier is present in the polymeric composition in an amount of from about 1000 ppm to about 3000 ppm. Examples of suitable modifiers that function as both clarifiers and nucleators include without limitation, a powdered sorbitol sold as MILLAD 3988 by Milliken Chemical of Spartanburg, S.C.; a sorbitol-based modifier sold as IRGACLEAR DM-LO by Ciba Specialty Chemicals; and an organophosphate sold as ADK NA-21, by Amfine Chemical. Without limitation an example of suitable modifiers that are nucleators are phosphate esters sold as ADK Na-11 (Na-11) and ADK Na-21 (Na-21) by Amfine Chemical.

In an embodiment, a modifier may be added to the polymeric composition in the form of a powder or a fluff after the polymerization process but before the polymer is melted and formed into pellets. The modifier may also be added in the form of a powder or compounded masterbatch during the formation of the preform. Techniques for blending polymeric components may be used. Such techniques are known to one skilled in the art. Examples of suitable blending techniques include without limitation solution blending, solid state physical admixture, molten state admixture, extrusion admixture, roll milling, screw extrusion, and the like.

In an embodiment, the polymeric composition may contain additives as necessary to impart desired physical properties. Examples of additives include without limitation stabilizers, ultra-violet screening agents, oxidants, anti-oxidants, anti-static agents, ultraviolet light absorbents, fire retardants, processing oils, mold release agents, catalyst neutralizers, slip agents, antistatic agents, coloring agents, pigments/dyes, fillers, and/or the like with other components. The additives may be added in amounts effective to suit the particular needs or desires of a user or maker, and various combinations of the additives may be used. For example, stabilizers or stabilization agents may be employed to help protect the polymer resin from degradation due to exposure to excessive temperatures and/or ultraviolet light. The aforementioned additives may be used either singularly or in combination to form various formulations of the polymer resin. These additives may be included in amounts effective to impart the desired properties. Effective additive amounts and processes for inclusion of these additives to polymeric compositions are known to one skilled in the art.

The polymeric composition may be converted to an intermediate article, referred to as a preform, which may be subsequently converted to an end-use article. Without limitation, examples of preforms include films, sheets, tubes, and un-blown articles, and examples of end-use articles include bottles, cups, containers, plates, etc. Polymeric compositions of the type disclosed herein may be converted into a preform or end-use article through a variety of plastic shaping processes. Plastic shaping processes are known to one skilled in the art and include without limitation blow molding and thermoforming.

In blow molding the polymeric composition is heated to form a molten tube. The molten tube is then blown to conform to the interior of a cooled blow mold using compressed air. Methods of blow molding include extrusion, injection and injection-stretch.

In extrusion blow molding, a dry form of a polymeric composition, e.g., pellets, is first loaded into a hopper. The dry polymeric composition is converted to a molten form as it moves through a heating chamber and is eventually forced or extruded through a small opening or die. The extruded tube, called a parison descends vertically into a split cavity mold. As the mold closes the top and bottom are sealed. Air is then injected to expand the plastic against the sides of the mold with the shape desired in the finished product. The extruded plastic is cooled typically through the use of blowers or by immersion in water.

In injection blow molding, the polymeric composition in pellet form is fed into a hopper where it is formed into a parison or preform. The preform is then heated to generate a tempered intermediate that can be shaped using air and/or mechanical devices into the contours of a mold. In injection-stretch blow molding, a preform is heated and stretched prior to a final blow forming in a blow mold.

Thermoforming consists of heating a thermoplastic sheet to a formable plastic state and then applying air and/or mechanical assists to shape it to the contours of a mold. Air pressure may range from atmospheric to several hundred psi. Up to approximately 14 psi (atmospheric pressure), the pressure is obtained by evacuating the space between the sheet and the mold in order to utilize this atmospheric pressure. This range, known as vacuum forming, will give satisfactory reproduction of the mold configuration in the majority of forming.

In an embodiment, the polymeric composition may be used to produce a film or sheet that may serve as a preform or an end-use article having the desired optical properties. Alternatively, the films or sheets of this disclosure may function as layer that caps another material, e.g., resin, or substrate, thereby imparting desirable optical properties to another material. Examples of resins which the polymeric composition may cap to increase gloss include without limitation polypropylene homopolymers, polypropylene random copolymers, polypropylene impact copolymers, and mineral filled polypropylenes. The polymeric composition may also be used as a layer which caps resins types such as polyethylene, PET, EVOH, PA provided a suitable compatibilizing agent or adhesive layer is utilized to bond the materials. Suitable compatibilizing agents, their effective amounts and methods for inclusion are known to one of ordinary skill in the art. In an embodiment, the cap layer may have a thickness of from about 25 mm or greater.

The preform may be converted to an end-use article by any suitable method. In an embodiment, the preform is converted to an end-use article by a plastics shaping process such as those described in this disclosure. Examples of end use articles into which the polymeric composition may be formed include pipes, films, bottles, fibers, containers, cups, lids, plates, trays, car parts, blister packs, and so forth. In an embodiment, the end-use article is a packaging container for a consumer product, a food storage container, or a beverage cup. Additional end use articles would be apparent to those skilled in the art. Conditions and processes for the conversion of a preform to an end-use article are known to one skilled in the art.

End-use articles produced from preforms in accordance with the present disclosure have a high gloss retention, meaning that a significant amount of the gloss exhibited by the preform remains after forming the end-use article. The gloss of the preform and end-use article is determined in accordance with ASTM method D 523. The gloss retention upon conversion of a preform to an end-use article may be calculated according to equation 1
GR(%)=(Gloss_{end}/Glossₚᵣₑ)×100 (1)
where GR is the gloss retention in percent, Gloss_{end} is the gloss of the end-use article and Glossₚᵣₑ is the gloss of the preform. In an embodiment, end-use articles comprised of PM of this disclosure have a GR of equal to or greater than about 40%, 50%, 60%, or 70%. In an embodiment, the GR has an upper limit of about 80%.

### EXAMPLES

The invention having been generally described, the following examples are given as particular embodiments of the invention and to demonstrate the practice and advantages thereof. It is understood that the examples are given by way of illustration and are not intended to limit the specification of the claims in any manner. Unless otherwise indicated, physical properties were determined in accordance with the test methods previously identified in the detailed description.

### Example 1

The optical and mechanical properties of four polypropylene compositions containing a nucleator or clarifier were compared. Sample 3289MZ is a polypropylene homopolymer, sample 6289MZ is a polypropylene random copolymer, sample M3282MZ is a metallocene-catalyzed polypropylene homopolymer, and sample 4280W is a polypropylene impact copolymer. All samples were clarified with MILLAD 3988 except for 4280W, which was nucleated with sodium benzoate. Other resin characteristics are detailed in Table II.

TABLE II

| | | Haze in 50 ml | | | | |
|---|---|---|---|---|---|---|
| | Melt Flow Rate | injection-molded | Additive | C2 levels^{#} | | |
| Sample | (g/10 min) | plaque (%) | (ppm) | (%) | Cat* | Type** |
| 3289MZ | 1.8 ± 0.01 | 23.0 ± 0.35 | 1930 | 0 | ZN | HiPP |
| 6289MZ | 1.3 ± 0.01 | 13.8 ± 0.07 | 1850 | 2.2 | ZN | RCP |
| M3282MZ | 2.2 ± 0.01 | 23.6 ± 0.34 | 1890 | 0 | M | miPP |
| 4280W | 1.6 ± 0.02 | 99.6 ± 0.47 | NA | 9 | ZN | ICP |

*ZN = Ziegler-Natta catalyst, M = metallocene catalyst
**HiPP = homopolymer, isotactic polypropylene; RCP = random copolymer; miPP = metallocene isotactic polypropylene; and ICP = heterophasic polypropylene impact copolymer
^{#}weight percent ethylene in the C₂/C₃ copolymer

Each of these resins were converted to a sheet as the preform and then processed further into cups using a thermoformer. Sheet samples were extruded on a Reifenhauser Mirex-W sheet extruder. The extruder has an 80-mm, 33:1 L/D, barrier screw with Maddox and pineapple mixing sections. The sheet die has a symmetrical, coat hanger manifold. The polishing stack was run in an upstack configuration. The polished rolls are 16 inches wide, and each is equipped with a temperature control unit.

### Example 2

Preform sheets were produced having a thickness of 1.2 mm or 1.95 mm and then converted into cups. Portion cups were formed with an Illig RDM 54K thermoformer. The former has longitudinal row control for both upper and lower infrared ceramic heaters. The former conducts solid phase pressure forming with a plug assist made of Hytac-B1X. The forming mold was polished aluminum and trimmed the cups in the forming station. Portion cups 3.667 inches wide and 2 inches deep were produced from 47 mil and 78.6 mil thick extruded sheet. Conditions for the plastic shaping processes used in the formation of the preform sheets and end-use cups are. given in Table III.

TABLE III*

| | Sheet | | | | | |
|---|---|---|---|---|---|---|
| | thickness | | 3289MZ | 6289MZ | M3282MZ | 4280W |
| Extruder Barrel | | | 230 | 230 | 230 | 230 |
| Temperatures (° C.) | | | | | | |
| Extruder Die | | | 250 | 250 | 250 | 250 |
| Temperatures (° C.) | | | | | | |
| Melt Temperature (° C.) | 1.2 | mm | 242 | 244 | 248 | 247 |
| | 1.95 | mm | 248 | 250 | 263 | 255 |
| Roll temperatures | 1.2 | mm | 70/80/70 | 70/80/70 | 80/90/80 | 70/80/70 |
| (bottom/middle/top) (° C.) | 1.95 | mm | 70/80/70 | 50/60/50 | 70/80/70 | 70/80/70 |
| Average line speed | | | 3.59 | 3.62 | 3.38 | 3.61 |
| (m/min) | | | | | | |
| Sheet temperature off roll | 1.2 | mm | 89 | 89 | 100 | 88 |
| stack (° C.) | 1.95 | mm | 141 | 124 | 138 | 133 |
| Top Oven Temperatures | 1.2 | mm | 408 | 386 | 388 | 414 |
| (° C.) | 1.95 | mm | 432 | 418 | 422 | 434 |
| Bottom Oven | 1.2 | mm | 418 | 396 | 398 | 414 |
| Temperatures (° C.) | 1.95 | mm | 442 | 428 | 428 | 444 |
| Average forming | 1.2 | mm | 154 | 141 | 155 | 153 |
| temperature (° C.) | 1.95 | mm | 157 | 144 | 158 | 158 |

*1.2 mm sheet conditions on the upper line of any given cell.

### Example 3

The haze, clarity and gloss of the preform 1.2 and 1.95 mm sheet are given in Tables IV.A and IV.C respectively while these values for the end-use cups are given in given in Tables IV.B and IV.D, respectively. All optical properties were measured as an average of three positions on the sheet or as an average of five cups. Haze and clarity were measured on a BYK-Gardner Haze-Gard Plus in accordance with ASTM D 1003 and SOP/CAL 47.0. Gloss was measured on a BYK-Gardner micro-TRI-gloss at 20° in accordance with ASTM D 523 and SOP/CAL 46.0. Error bars shown in the figures were pre-determined in a component of variation analysis on the equipment and are given in Table V.

TABLE IV.A
1.2 mm Sheet

| Grade | Haze | Clarity | Top/Inner Gloss | Bottom/Outer Gloss |
|---|---|---|---|---|
| 6289MZ | 16.4 | 99.6 | 121.3 | 121 |
| 3289MZ | 29 | 99 | 106.7 | 125.9 |
| M3282MZ | 28 | 98.8 | 109.9 | 109 |
| 4280W | 103 | 17.7 | 53.8 | 71.5 |

TABLE IV.B
1.2 mm Cup

| Grade | Haze | Clarity | Top/Inner Gloss | Bottom/Outer Gloss |
|---|---|---|---|---|
| 3289MZ | 6.52 | 80.5 | 54.1 | 56.4 |
| 6289MZ | 6.88 | 75.6 | 53.2 | 48.6 |
| M3282MZ | 3.05 | 88.1 | 70.1 | 65.2 |
| 4280W | 63.2 | 49.1 | 23.5 | 18.4 |

TABLE IV.C
1.95 mm Sheet

| Grade | Haze | Clarity | Top/Inner Gloss | Bottom/Outer Gloss |
|---|---|---|---|---|
| 6289MZ | 37.4 | 84.9 | 78.8 | 91.8 |
| 3289MZ | 55.3 | 96.8 | 84.2 | 88.6 |
| M3282MZ | 50.7 | 97.3 | 91.5 | 92.3 |
| 4280W | 97.1 | 43.3 | 48.1 | 72.4 |

TABLE IV.D
1.95 mm Cup

| Grade | Haze | Clarity | Top/Inner Gloss | Bottom/Outer Gloss |
|---|---|---|---|---|
| 3289MZ | 11.3 | 63.8 | 45.3 | 43.5 |
| 6289MZ | 10.4 | 58.9 | 40.1 | 35.2 |
| M3282MZ | 6.55 | 75.2 | 71.9 | 74.3 |
| 4280W | 67.6 | 35.6 | 9.8 | 14 |

TABLE V
Optical Property Standard Deviations.

| | Sheet Sample | Cup Sample |
|---|---|---|
| Property | Deviation | Deviation |
| Haze | 2.21 | 0.36 |
| Clarity | 0.3 | 0.2 |
| Top/Interior Gloss | 3.3 | 7.0 |
| Bottom/Exterior Gloss | 2.5 | 6.8 |

The gloss retention of the end-use articles, as calculated according to the Equation (1) in this disclosure, is presented for the 1.2 mm and 1.95 mm constructs in tables VI.A and VI.B, respectively.

TABLE VI.A
Gloss Retention

| 1.2 mm | Inside | Outside |
|---|---|---|
| M3282MZ | 59.33 | 49.63 |
| 3289MZ | 52.86 | 42.97 |
| 6289MZ | 43.97 | 40.07 |
| 4280W | 32.87 | 34.20 |

TABLE VI.B
Gloss Retention

| 1.95 mm | Inside | Outside |
|---|---|---|
| M3282MZ | 81.20 | 77.90 |
| 3289MZ | 51.66 | 51.13 |
| 6289MZ | 44.67 | 43.68 |
| 4280W | 29.11 | 13.54 |

The optical properties results of the 1.2-mm and 1.95-mm sheet samples are given in Tables IV.A and IV.C. For both gauges, the random copolymer 6289MZ had the lowest haze, as expected. The 3289MZ and M3282MZ grades had equivalent haze performance. Each grade had very good clarity and gloss. The optical properties results of the portion cups made with each sheet gauge are shown in Figures IV.B and IV.D. Despite having the lower sheet clarity, the 6289MZ had equivalent haze to the 3289MZ portion cup in the thinner gauge and slightly lower haze in the thicker gauge. On the other hand, the haze of the M3282MZ grade was 53% lower than 3289MZ in the thinner gauge and 42% lower in the thicker gauge. The M3282MZ grade also had better clarity than the other grades. The results demonstrate improved gloss retention for the constructs comprising the M3282MZ resin which comprises the mPP and clarifier.

While preferred embodiments of the invention have been shown and described, modifications thereof can be made by one skilled in the art without departing from the spirit and teachings of the invention. The embodiments described herein are exemplary only, and are not intended to be limiting. Many variations and modifications of the invention disclosed herein are possible and are within the scope of the invention. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). Use of the term “optionally” with respect to any element of a claim is intended to mean that the subject element is required, or alternatively, is not required. Both alternatives are intended to be within the scope of the claim. Use of broader terms such as comprises, includes, having, etc. should be understood to provide support for narrower terms such as consisting of, consisting essentially of, comprised substantially of, etc.

Accordingly, the scope of protection is not limited by the description set out above but is only limited by the claims which follow, that scope including all equivalents of the subject matter of the claims. Each and every claim is incorporated into the specification as an embodiment of the present invention. Thus, the claims are a further description and are an addition to the preferred embodiments of the present invention. The discussion of a reference in the Description of Related Art is not an admission that it is prior art to the present invention, especially any reference that may have a publication date after the priority date of this application. The disclosures of all patents, patent applications, and publications cited herein are hereby incorporated by reference, to the extent that they provide exemplary, procedural or other details supplementary to those set forth herein.

What is claimed is:

1. A method of manufacturing an end-use article from a polymeric composition comprising forming an intermediate article of the polymer composition into the end-use article having a gloss retention of greater than about 40%.

2. The method of claim 1 wherein the gloss retention is from about 50% to about 80%.

3. The method of claim 1 wherein the polymeric composition comprises a polypropylene homopolymer or copolymer.

4. The method of claim 3 wherein the polypropylene homopolymer or copolymer is metallocene-catalyzed.

5. The method of claim 3 wherein the polymeric composition is a random ethylene-propylene copolymer.

6. The method of claim 5 wherein the random ethylene-propylene copolymer comprises from about 0.2 to about 5.0 weight percent ethylene.

7. The method of claim 1 wherein the polymeric composition further comprises a clarifier, a nucleator, or both.

8. The method of claim 7 wherein the polymeric composition comprises from about 300 ppm to about 4000 ppm by weight of the clarifier, nucleator, or both.

9. The method of claim 7 wherein the nucleator is a sorbitol compound, dibenylidene sorbitol, a metal benzoate, sodium benzoate, lithium benzoate, organophosphate, talc, a pine rosin, or combinations thereof.

10. The method of claim 7 wherein the nucleator is a sorbitol compound and is present in amounts of from about 1000 ppm to about 3000 ppm.

11. The method of claim 7 wherein the nucleator is a metal benzoate and is present in amounts of from about 500 ppm to about 3000 ppm.

12. The method of claim 7 wherein the nucleator is an organophosphate and is present in amounts of from about 300 ppm to about 1200 ppm.

13. The method of claim 7 wherein the nucleator is talc and is present in amounts of from about 1000 ppm to about 4000 ppm.

14. The method of claim 7 wherein the nucleator is a pine rosin and is present in amounts of from about 1000 ppm to about 4000 ppm.

15. The method of claim 1 wherein the intermediate article, the end-use article, or both are formed by sheet extrusion, film extrusion, extrusion thermoforming, extrusion blow molding, injection blow molding, or injection stretch blow molding.

16. The method of claim 1 wherein the intermediate article is a sheet and the end-use article is a thermoform.

17. The method of claim 1 wherein the intermediate article is hollow and the end-use article is a blown article.

18. The method of claim 1 wherein the intermediate article is a co-extruded or laminated structure.

19. An end-use article produced by the method of claim 1.

20. A method of manufacturing an end-use article from a polymeric material comprising producing an intermediate polymeric article, determining the gloss of the intermediate article, converting the intermediate article to an end-use polymeric article, determining the gloss of the end-use polymeric article and calculating the gloss retention of the end-use article.

21. A method of increasing the gloss retention of a polymeric article, comprising: fabricating an intermediate article from a polymeric composition comprising a metallocene-catalyzed polypropylene and a nucleator, clarifier, or both; and further processing the intermediate article to an end-use article.
